(19) United States
(12) Patent Application Publication
(10) Pub. No.: US 2004/0172663 A1
(43) Pub. Date: Sep. 2, 2004

(54) Video receiver

(75) Inventors: Yasuhiro Hayashi, Takefu-shi (JP); Yoshinori Mizushima, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 10/782,914

(22) Filed: Feb. 23, 2004

(30) Foreign Application Priority Data
Feb. 28, 2003 (JP) 2003-053358

(51) Int. Cl. H04N 7/173; H04N 5/04; H04N 7/16; H04N 9/44

(52) U.S. Cl. 725/139; 725/135; 725/133; 725/131; 725/151

(57) ABSTRACT

This invention is intended to notify a user that a clock count means included in a video receiver has been corrected. The video receiver 15 includes a microcomputer 10. An antenna 1, a tuner 2, and a monitor output unit 20 are connected to the video receiver 15. The microcomputer 10 of the video receiver 15 includes the clock count section 6, a time data extraction processing section 5, and a clock correction processing section 7. A broadcast signal input through the antenna 1 and the tuner 2 is input to the clock data extraction processing section 5 of the microcomputer 10, and the clock data extraction processing section 5 acquires correction time information. The clock correction processing section 7 compares data on time counted by the clock count section 6 with the correction time information, and thereby corrects the clock count section 6. By outputting the time data obtained by the clock count section 6 and the correction time information both of which are input to the clock correction processing section 7 to the monitor output unit 20, the user is notified that the clock count section 6 has been corrected.

### BACKGROUND OF THE INVENTION

1. Field of the Invention

The present invention relates to a video receiver receiving a broadcast transmitted from a broadcasting station.

2. Description of the Related Art

A video receiver receives a broadcast signal transmitted from a broadcast station, and outputs a video and a voice to a monitor output section based on the received broadcast signal. A user who uses the video receiver can thereby view and listen to a broadcast program broadcast by the broadcasting station.

The video receiver also includes time count means for counting time. The time counted by the time count means is often used as a base on which the video receiver operates. The user can check time by outputting the time counted by the time count means to the monitor output section or the like.

Further, the video receiver includes time correction means for correcting the time count means. Since the time count means generates an error in counting as the means counts time, the time correction means corrects the time count means at intervals of certain time.

If the time correction means is to correct the time count means, the time correction means uses time information included in the broadcast signal. An NHK (Nippon Hoso Kyokai) broadcasting station, for example, transmits a time signal sound at fixed time every day. By detecting this time signal sound, the time correction means can correct the time count means.

As broadcast programs that transmit broadcast signals including the time information, there are recently known an EPG (Electric Program Guide) broadcast, an EDS (Extended Data Service) broadcast, and the like. Using the time information transmitted together with the broadcast signal by one of these broadcast programs, the time correction means can correct the time count means.

However, the conventional video receiver has the following disadvantages. Even if the time correction means corrects the time count means, the user is not at all notified of a process performed by the time correction means. As a result, even if the time correction means does not operate for some reason and does not correct the time count means, the user is unable to recognize that the time correction means does not correct the time count means.

If the time count means remains uncorrected, the time count means cannot count time correctly. Since the time based on which the video receiver operates is inaccurate, the video receiver cannot operate as the user plans.

### SUMMARY OF THE INVENTION

It is, therefore, an object of the present invention to provide a video receiver capable of notifying a user that time correction means has corrected time count means.

According to one aspect of the present invention, there is provided a video receiver for inputting a broadcast signal received through an antenna and a tuner, comprising: a microcomputer controlling an operation of the video receiver; time count means for counting time; time information extraction means for extracting time information included in the input broadcast signal, and for acquiring correction time information; and time correction means for correcting the time count means based on the correction time information extracted by the time information extraction means, wherein a notification that the time correction means has corrected the time count means is made by a monitor output unit connected to the video receiver.

According to the video receiver of the present invention, a notification that the time count means has been corrected is output to the monitor output unit to notify the user who uses the video receiver that the time count means has been corrected. It is possible to ensure that the user recognizes whether the time count means included in the video receiver has been corrected. If the time count means has not been corrected for some reason, the user can promptly take necessary measures.

Further, the video receiver can be constituted so that the notification that the time correction means has corrected the time count means is made by displaying the notification on a television monitor connected, as the monitor output unit, to the video receiver.

With this constitution, the notification that the time count means has been corrected is displayed on the television monitor to notify the user of the correction. Therefore, the user can visually recognize that the correction has been made.

In addition, the video receiver can be constituted so that one of an EPG, an EDS, a CCD, and a T'TEXT is received as a broadcast of transmitting the broadcast signal for acquiring the correction time information, the EPG representing an electric program guide, the EDS representing an extended data service, the CCD representing closed caption data, and the T'TEXT representing a teletext.

With this constitution of the video receiver of the present invention, by receiving one of the EPG, EDS, CCD, and T'TEXT broadcasts, the correction time information can be acquired.

If one of the EPG, EDS, CCD, and T'TEXT broadcasts is received, present time information can be acquired at arbitrary time of a day. According to the video receiver of the present invention, it is thereby possible to acquire the correction time information at the arbitrary time of a day and to correct the time count means. It is also possible to notify the user of the correction of the time count means made at the arbitrary time.

Furthermore, the video receiver can be constituted so that a voice signal representing a time signal sound is received as a broadcast of transmitting the broadcast signal for acquiring the correction time information, at a certain time.

With this constitution of the video receiver of the present invention, by receiving the voice signal representing the time signal sound, the time count means can be corrected. It is also possible to notify the user that the time correction means has been corrected based on this time signal sound.

### BRIEF DESCRIPTION OF THE DRAWINGS

FIG. 1 is a block diagram of a video receiver in one embodiment of the present invention;

FIGS. 2A and 2B illustrate one example of an operation menu displayed on a television monitor;

FIG. 3 is a flow chart which illustrates one example of procedures for causing the video receiver to operate;

FIGS. 4A and 4B illustrate one example of displaying time information on the television monitor;

FIG. 5 is a flow chart which illustrates one example of procedures for causing the video receiver to operate; and

FIG. 6 is a flow chart which illustrates one example of procedures for causing the video receiver to operate.

### DETAILED DESCRIPTION OF THE PREFERRED EMBODIMENT

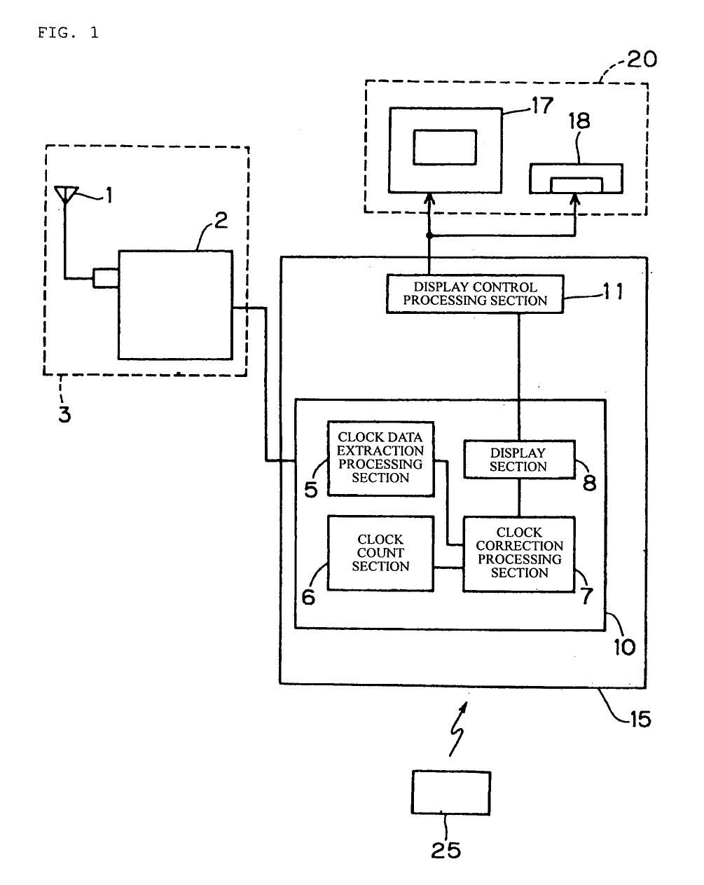

One embodiment of the present invention will be described hereinafter with reference to FIGS. 1 to 6. FIG. 1 is a block diagram of a video receiver 15 in one embodiment of the present invention. An input section 3 and a monitor output unit 20 are connected to the video receiver 15 shown in FIG. 1.

The input section 3 includes an antenna 1 and a tuner 2. A broadcast wave broadcast by a broadcasting station is selected and received by the antenna 1 and the tuner 2. Namely, the tuner 2 selectively receives only a broadcast wave at a specific frequency (on a specific channel) set to the tuner 2, and inputs a broadcast signal on the selected specific channel. The broadcast signal input to the tuner 2 is input to the video receiver 15 to be described later.

The channel selected by the tuner 2 is set to the tuner 2 by the video receiver 15. If a user who uses this video receiver 15 conducts an operation of selecting a desired channel to the video receiver 15, the selected channel is set to the tuner 2.

If a time count section 6 to be described later makes a correction, a channel for acquiring correction time information set to the video receiver 15 is set to the tuner 2.

The video receiver 15 includes a microcomputer 10 and a display control processing section 11. The microcomputer 10 includes a CPU (central processing unit), a ROM (read only memory), and a RAM (random access memory), none of which are shown in FIG. 1.

In the ROM of the microcomputer 10, a clock data extraction processing section 5, a clock count section 6, a clock correction processing section 7, and a display section 8 shown in FIG. 1 are provided. Each of these constituent elements is modularized by a program which can be subjected to an arithmetic processing and which is provided in the ROM of the microcomputer 10.

The clock data extraction processing section 5 performs processings of extracting the time information from the received broadcast signal, and of acquiring the correction time information. The clock data extraction processing section 5 inputs the broadcast signal output from the tuner 2.

The broadcast signal includes a video signal and a voice signal. This broadcast signal is often transmitted including the time information for notifying the user of present time. The broadcast signal is often transmitted including character information, and the time information is sometimes included in this character information.

The clock data extraction processing section 5 performs processings of extracting the time information included in this broadcast signal, and of acquiring the correction time information for correcting the clock count section 6 to be described later. The clock data extraction processing section 5 corresponds to time information extraction means.

The clock count section 6 counts time. The clock count section 6 corresponds to a timer included in the video receiver 15. The clock count section 6 counts time based on a clock pulse which is a base on which the microcomputer 10 operates. Based on data on the time counted by the clock count section 6, present time information is provided to the video receiver 15. The clock count section 6 corresponds to time count means.

The clock correction processing section 7 corrects the clock count section 6. The clock correction processing section 7 inputs the correction time information output from the clock data extraction processing section 5 and the time data output from the clock count section 6.

The clock correction processing section 7 compares the input time data with the input correction time information, detects a counting error of the clock count section 6, and corrects the time data of the clock count section 6 based on the detected error. The clock correction processing section 7 corresponds to time correction means for correcting the time count means.

The display section 8 generates display data to be output to a television monitor 17 or a display tube 18 to be described later. The display section 8 inputs the time data and the correction time information from the clock correction processing section 7.

The display section 8 generates the display data including video data for displaying the time data and the correction time information on a screen of the television monitor 17 based on the time data and the correction time information thus input. The display section 8 generates the display data for displaying the time data and the correction time information on the display tube 18. The display data generated by the display section 8 is output to the display control processing section 11 to be described later.

The ROM of the microcomputer 10 stores an input operation control program, not shown, for displaying an operation menu on the screen of the television monitor 17, and for reading a content input by user's operation based on the displayed operation menu.

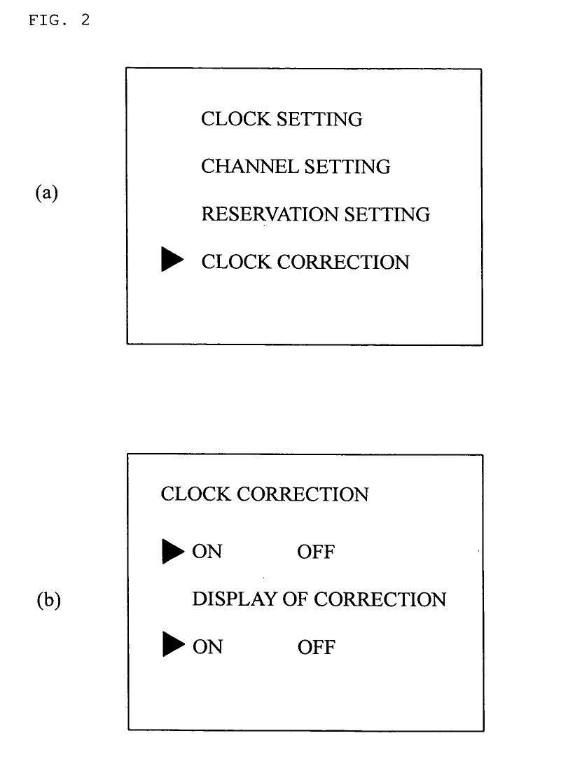

FIGS. 2A and 2B illustrate the operation menu displayed on the screen of the television monitor 17. FIGS. 2A and 2B illustrate examples of items displayed as the operation menu. As shown in FIG. 2A, “clock setting”, “channel setting”, “reservation setting”, and “clock correction” are displayed as input operation items to be operated based on the display of the operation menu. Among these items, “clock correction” is an item for making a setting related to correction of the clock count section 6.

Based on the display of the operation menu shown in FIG. 2A, “time correction” is selected. FIG. 2B illustrates an example of the operation menu for setting conditions of “clock correction”. As shown in FIG. 2B, “clock correction” and “correction display” are displayed as input operation items.

Based on the display of the operation menu shown in FIG. 2B, “ON” of “clock correction” is selected and input, whereby a setting is made so as to correct the clock count section 6. If “OFF” of “clock correction” is selected and input, a setting is made so as not to correct the clock count section 6.

Further, if “ON” of “correction display” is selected and input based on the display of the operation menu shown in FIG. 2B, a setting is made so as to output a status of correcting the clock count section 6 to the monitor output unit 20. If “OFF” of “correction display” is selected and input, a setting is made so as not to output the status of correcting the clock count section 6 to the monitor output unit 20.

Furthermore, as items of the operation menu for “clock correction”, those for setting other conditions for correcting the clock count section 6 are provided although not shown in FIG. 2B.

The other conditions for correcting the clock count section 6 include a broadcast channel for acquiring the correction time information. The other conditions also include the time at which the clock count section 6 is corrected. As the time at which the clock count section 6 is corrected, time in a time zone in which the time information is broadcast on the selected broadcast channel is set.

The ROM of the microcomputer 10 shown in FIG. 1 further stores a clock correction control program. The clock correction control program is part of a program for allowing the microcomputer 10 to control the operation of the video receiver 15. By allowing the microcomputer 10 to execute the clock correction control program, the clock count section 6 can be corrected.

The display control processing section 11 shown in FIG. 1 generates an operation signal to display the time information on the television monitor 17 and on the display tube 18 based on the display data input from the display section 8.

The display control processing section 11 is controlled to output the time information to either the television monitor 17 or the display tube 18 in accordance with the user's operation. The display control processing section 11 generates the operation signal to display the time information on one of the television monitor 17 and the display tube 18 designated by the user's operation or the operation signal to display the time information on both the television monitor 17 and the display tube 18. The display control processing section 11 then outputs the time information in accordance with this operation signal to one of the television monitor 17 and the display tube 18 designated by the user's operation or both of them.

The monitor output unit 20 includes the television monitor 17 and the display tube 18. The television monitor 17 displays a video and characters on the screen. The television monitor 17 inputs the display data for displaying the time data and the correction time information obtained by the clock count section 6 on the television monitor 17 by the display control processing section 11. It is thereby possible to display the time data and the correction time information obtained by the clock data extraction processing section 5 on the television monitor 17.

The television monitor 17 includes a loudspeaker for outputting the voice. The video receiver 15 is also constituted so that if the clock correction processing section 7 corrects the clock count section 6, a voice signal that represents that the clock correction processing section 7 has corrected the clock count section 6 is output to the loudspeaker of the television monitor 17 and so that the user can be notified by a voice that the clock count section 6 has been corrected.

The display tube 18 is comprised of a display light emitting element such as a light emitting diode. This display light emitting element displays the time data and the correction time information obtained by the clock count section 6.

The video receiver 15 further includes recording means which is not shown in FIG. 1. This recording means can record a content of the broadcast program received by the video receiver 15. By setting a recording start time to this recording means in advance, the recording means can make a recording reservation for starting recording at the set time.

As this recording means, any one of various types of recording means can be provided. Namely, any one of various recording means corresponding to various types of recording mediums such as a video tape or a magnetic disk can be provided.

The video receiver 15 also includes an operation remote controller 25. The operation remote controller 25 includes various operation keys necessary to operate the video receiver 15 as well as operation menu display keys, channel selection keys, and recording keys.

The operation menu display keys are operation keys for displaying the operation menu on the television monitor 17 of the monitor output unit 20. By operating the operation menu display keys and displaying the operation menu on the television monitor 17, settings related to the correction of the clock count section 6 can be made.

The channel selection keys are operation keys for selecting the channel to be received by the video receiver 15. If the channel selection operation is performed by the channel selection keys, a reception frequency of the selected channel is set to the tuner 2, whereby the user can view and listen to the broadcast content of the selected channel on the television monitor 17.

The recording keys are operation keys for recording the received program by operating the recording means.

The operation remote controller 25 also includes clock correction keys. The clock correction keys are operation keys for correcting the clock count section 6. By operating the clock correction keys, the clock count section 6 can be arbitrarily corrected.

The video receiver 15 further includes operation discrimination means which is not shown. The operation discrimination means discriminates a content of an operation for the operation remote controller 25. If discriminating the content of the operation for the remote controller 25, the operation discrimination means outputs a signal that represents the content of the operation to the microcomputer 10.

The microcomputer 10 thereby discriminates the content of the operation for the remote controller 25 performed by the user, and controls the operation of the video receiver 15 in accordance with the discriminated content of the operation.

If discriminating that the clock correction keys are operated, the microcomputer 10 controls the clock data extraction processing section 5, the clock count section 6, and the clock correction processing section 7 so as to correct the clock count section 6.

The video receiver 15 described above can receive various broadcasts in which each of broadcast signals includes the time data. Examples of the broadcasts received by this video receiver 15 include NHK, EPG (Electric Program Guide), EDS (Extended Data Service), CCD (Closed Caption Data), and T'TEXT (Teletext) broadcasts.

If the video receiver 15 receives the NHK broadcast, the video receiver 15 can acquire the correction time information by a voice signal that produces the time signal sound at fixed time every day. If the video receiver 15 receives one of the EPG, EDS, CCD, or T'TEXT broadcasts, in each of which the video signal includes the time information as character information, the video receiver 15 can acquire the correction time information by the broadcast.

Further, each of the EPG, EDS, CCD, and T'TEXT broadcasts in which the time information is included in the video signal is transmitted all day long. Therefore, the video receiver 15 acquires the correction time information at arbitrary time.

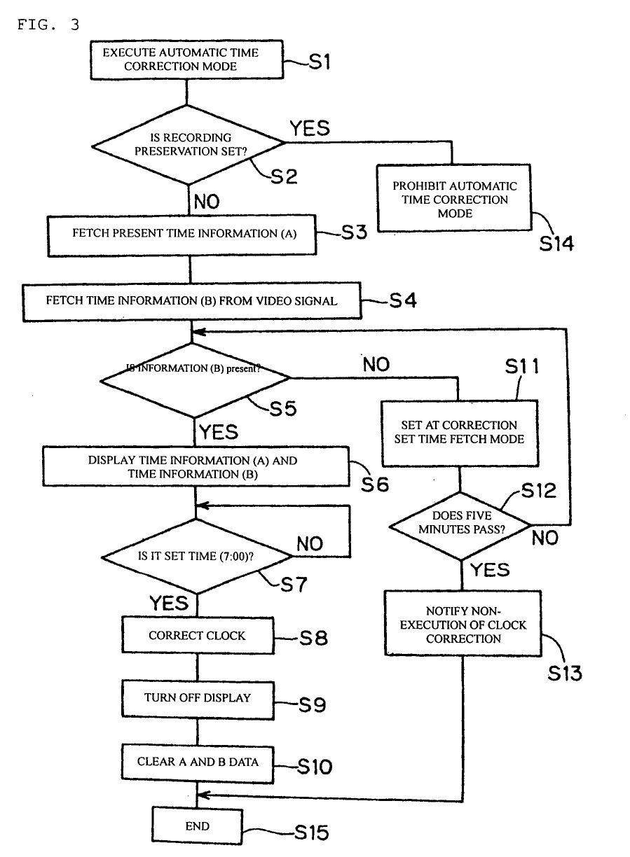

Examples of the operation of the video receiver 15 will next be described with reference to FIGS. 3 to 6 as well as FIGS. 1, 2A and 2B. [Operation Example 1], [Operation Example 2], and [Operation Example 3] will be described separately.

### OPERATION EXAMPLE 1

Operation example 1 will be described with reference to FIG. 3 as well as FIGS. 1, 2A, and 2B. FIG. 3 is a flow chart which illustrates one example of the operation of the video receiver 15. FIG. 3 also illustrates part of a flow chart of the clock correction control program.

The video receiver 15 is turned on. The video receiver 15 starts its operation, accordingly. Then the microcomputer 10 starts its operation, a program for controlling the video receiver 15 is executed, and the input operation control program and the clock correction control program are executed.

The video receiver 15 is operated and the operation menu shown in FIGS. 2A and 2B is displayed on the television monitor 17. Based on the display of the operation menu shown in FIGS. 2A and 2B, “clock correction” is selected, “ON” of “clock correction” is selected, and “ON” of “correction display” is selected.

By selecting “ON” of “clock correction”, the clock correction control program the flow chart of which is shown in FIG. 3 is executed. An automatic time correction mode is executed (in S1). It is then determined whether recording reservation is set (in S2).

If the recording reservation is not set (“NO” in S2), present time information (A) is fetched from the clock count section 6 (in S3). The time information (B) extracted by the clock data extraction processing section 5 from the video signal is fetched as the correction time information (in S4).

Next, it is detected whether the time information (B) has been fetched (in S5). If it is detected in the step S5 that the time information (B) has been fetched (“YES” in S5), the time information (A) and the time information (B) are displayed on one of or both of the television monitor 17 and the display tube 18 (in S6).

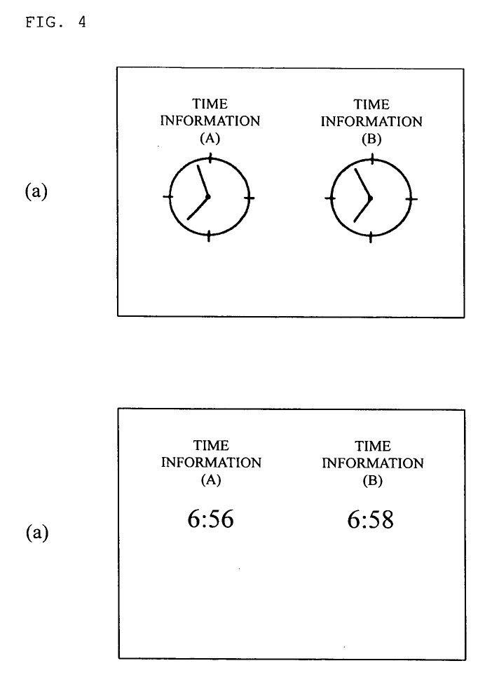

FIGS. 4A and 4B illustrate one example of displaying the time information (A) and the time information (B) on the television monitor 17. In FIGS. 4A and 4B, the example in which the time at which the clock count section 6 is corrected is set at seven o'clock.

In the example shown in FIG. 4A, clock images are displayed on the television monitor 17, and hands on the clocks are changed in accordance with the time information (A) and the time information (B), respectively. In the example shown in FIG. 4A, the time information (A) obtained by the time count section 6 is displayed left on the screen, and the time information (B) obtained by the clock data extraction processing section 5 is displayed right on the screen.

In the example shown in FIG. 4B, the time information (A) and the time information (B) are displayed by numeric values of the time. In the example shown in FIG. 4B, the time information (A) obtained by the time count section 6 is displayed left on the screen, and the time information (B) obtained by the clock data extraction processing section 5 is displayed right on the screen.

If the time information (A) and the time information (B) displayed on one of or both of the television monitor 17 and the display tube 18 are compared with each other, a shift of the time data counted by the clock count section 6 from actual time (the time information (B)) can be checked. It is thereby possible to check a time error generated by the clock count section 6.

Next, it is detected whether it is the time (e.g., seven o'clock) set as the time at which the clock count section 6 is corrected (in S7). The detection in the step S7 is carried out by comparing the time set as the time for correction with the time information (B).

If it is the time for correction (“YES” in S7), clock correction is made (in S8) and the time data of the time count section 6 is made coincident with the time information (B).

The display of the time information (A) and the time information (B) displayed on one of or both of the television monitor 17 and the display tube 18 is turned off (in S9). The time information (A) and the time information (B) are cleared, whereby the automatic time correction mode is finished (in S15).

If it is not detected in the step S5 that the time information (B) has been fetched (“NO” in S5), then the video receiver 15 turns into a correction set time fetch mode and the time (e.g., seven o'clock) set as the time at which the clock count section 6 is corrected is read (in S11).

It is then detected whether five minutes have passed since the time set as the time for correction (in S12). If five minutes have passed since the set time (“YES” in S12), it is notified that the clock correction has not been executed (in S13). The automatic time correction mode is finished (in S15).

If it is detected in the step S12 that five minutes have not passed yet since the set time (“NO” in S12), the processing returns to the step S5 in which it is detected whether the time information (B) has been fetched (in S5).

The notification in the step S13 may be made by displaying a notification on one of or both of the television monitor 17 and the display tube 18 or by a voice produced from the loudspeaker included in the video receiver 15.

If it is detected in the step S2 that the recording reservation is being executed (“YES” in S2), a processing of prohibiting the automatic time correction mode is performed (in S14). As a result, even if “clock correction” is set on the operation menu, the microcomputer 10 controls the clock correction processing section 7 not to correct the clock count section 6 and controls the display section 8 not to display the time information (A) and the time information (B) executed in the step S6.

If the automatic time correction mode is executed, the time information (A) and the time information (B) are displayed on one of or both of the television monitor 17 and the display tube 18 before the clock count section 6 is corrected until the clock count section 6 is corrected as described above in relation to the steps S6 to S8.

Through these steps, the user is notified of a moment the clock count section 6 is corrected. The user can thereby accurately recognize that the clock count section 6 has been corrected.

Furthermore, as described above in relation to the step S13, the user is also notified that the correction time information cannot be acquired from the video signal and that the clock correction cannot be made. The user can thereby promptly recognize that the clock count section 6 has not been corrected.

### OPERATION EXAMPLE 2

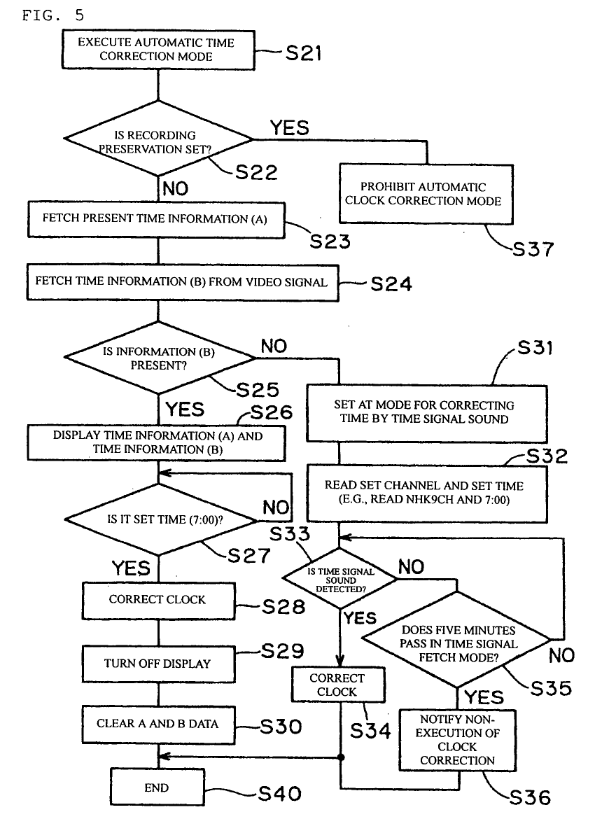

Operation example 2 will be described with reference to FIG. 5 as well as FIGS. 1, 2A, and 2B. FIG. 5 is a flow chart which illustrates one example of the operation of the video receiver 15. FIG. 5 also illustrates part of the flow chart of the clock correction control program.

The video receiver 15 is turned on. The video receiver 15 starts its operation, accordingly. Then the microcomputer 10 starts its operation, a program for controlling the video receiver 15 is executed, and the input operation control program and the clock correction control program are executed.

The video receiver 15 is operated and the operation menu shown in FIGS. 2A and 2B is displayed on the television monitor 17. Based on the display of the operation menu shown in FIGS. 2A and 2B, “clock correction” is selected, “ON” of “clock correction” is selected, and “ON” of “correction display” is selected.

By selecting “ON” of “clock correction”, the clock correction control program the flow chart of which is shown in FIG. 5 is executed. The automatic time correction mode is executed (in S21).

In the flow chart shown in FIG. 5, steps S21 to S30 are the same as the steps S1 to S10 of the flow chart shown in FIG. 3, a step S37 is the same as the step S14 shown in FIG. 3, and a step S40 is the same as the step S15 shown in FIG. 3. Therefore, these steps will not be described herein.

If it is not detected in the step S25 shown in FIG. 5 that the time information (B) has been fetched (“NO” in S25), the video receiver 15 is set at a mode for making time correction by a time signal sound (in S31).

The broadcast channel and the time set to make time correction are read by the time signal sound (in S32). As the broadcast channel for making time correction by the time signal sound, an NHK broadcast, for example, can be set. As the time for making time correction by the time signal sound, seven o'clock, for example, can be set. In this example, the time correction can be made by the time signal sound on the NHK broadcast at seven o'clock.

The time signal sound is detected (in S33). The detection of the time signal sound in the step S33 is carried out by determining whether the voice signal representing the time signal sound is input to the microcomputer 10 at the time set as the time at which the time correction is made.

If the time signal sound is detected (“YES” in S33), the clock is corrected (in S34). The clock correction in the step S34 is executed as follows. If the voice signal representing the time signal sound is input to the microcomputer 10, data on the time signal is input, as the correction time information, to the time correction processing section 7 by the clock data extraction processing section 5. The data on the time counted by the clock count section 6 is input to the clock correction processing section 7. The clock count section 6 is corrected based on the time signal data and the data on the time counted by the clock count section 6.

If the time signal sound is not detected in the step S33 (“NO” in S33), it is detected whether five minutes have passed in the time signal fetch mode (in S35). If the time signal sound is not detected after the passage of five minutes (“YES” in S35), the user is notified that time correction has not been made (in S36). If it is detected in the step S35 that five minutes have not passed (“NO” in S35), the processing returns to the step S33 in which the time signal sound is detected.

The notification that time correction has not been made in the step S36 may be made by displaying a notification on one of or both of the television monitor 17 and the display tube 18 or by a voice produced from the loudspeaker included in the video receiver 15.

### OPERATION EXAMPLE 3

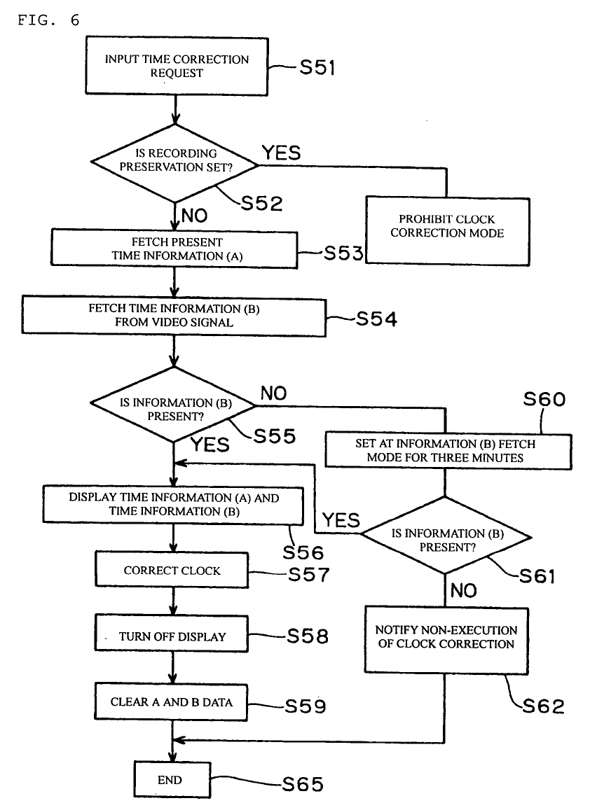

Operation example 3 will be described with reference to FIG. 6 as well as FIGS. 1, 2A, and 2B. FIG. 6 is a flow chart which illustrates one example of the operation of the video receiver 15. FIG. 6 also illustrates part of the flow chart of the clock correction control program.

The video receiver 15 is turned on. The video receiver 15 starts its operation, accordingly. Then the microcomputer 10 starts its operation, the program for controlling the video receiver 15 is executed, and the input operation control program and the clock correction control program are executed.

If it is detected that a time correction request is input by operating the time correction keys on the operation remote controller (in S51), the clock correction control program the flow chart of which is shown in FIG. 6 is executed.

It is detected whether recording reservation is set (in S52). If the recording reservation is not set (“NO” in S52), the present time information (A) is fetched from the clock count section 6 (in S53).

The time information (B) extracted by the clock data extraction processing section 5 from the video signal is fetched as the correction time information (in S54). Then it is detected whether the time information (B) is fetched (in S55). If it is detected that the time information (B) has been fetched (“YES” in S55), the time information (A) and the time information (B) are displayed on the television monitor 17 (in S56). Time correction is then made (in S57). Namely, the time data of the clock count section 6 is made coincident with the time information (B).

The display of the time information (A) and the time information (B) displayed on one of or both of the television monitor 17 and the display tube 18 is turned off (in S58). The time information (A) and the time information (B) are cleared (in S59), whereby the time correction processing based on the operation of the clock correction keys is finished (in S65).

If it is not detected in the step S55 that the time information (B) has been fetched (“NO” in S55), then the video receiver 15 sets at a mode for fetching the time information (B) for three minutes (in S60). If it is detected that the time information (B) has been fetched (“YES” in S61), the steps S56 to S65 are executed.

If it is not detected that the time information (B) has been fetched (“NO” in S61), the user is notified that time correction has not been made (in S62). The clock correction processing based on the operation of the clock correction keys is finished (in S65).

The embodiment has been described while assuming that the video receiver 15 includes the recording means. However, the video receiver does not necessarily include the recording means when carrying out the present invention. That is, when carrying out the present invention, it suffices that the video receiver can receive the broadcast signal including the correction time information.

If the video receiver 15 does not include the recording means, the step of determining whether the recording reservation is being executed and the step of performing the processing of prohibiting the automatic time correction mode while executing the recording reservation are not executed in the flow charts described above with reference to FIGS. 3, 5, and 6, respectively.

Furthermore, in the operation example based on FIG. 5, an instance, in which the correction time information is acquired from the broadcast signal on the channel for broadcasting the time signal if the correction time information cannot be acquired from the video signal on the channel including the correction time information, has been described. However, the correction time information may be acquired only by the time signal broadcast when carrying out the present invention.

According to the video receiver of the present invention, if the time count means, provided in the video receiver, for counting the time is corrected, the user is notified of the correction. It is possible to ensure that the user who uses the video receiver recognizes that the time count means has been corrected. In addition, if the time count means of the video receiver has not been corrected, the user can promptly take necessary measures.

What is claimed is:

1. A video receiver for inputting a broadcast signal received through an antenna and a tuner, comprising:
a microcomputer controlling an operation of the video receiver;
time count means for counting time;
time information extraction means for extracting time information included in the input broadcast signal, and for acquiring correction time information; and
time correction means for correcting the time count means based on the correction time information extracted by the time information extraction means, wherein
a notification that the time correction means has corrected the time count means is made by a monitor output unit connected to the video receiver.

2. The video receiver according to claim 1, wherein the notification that the time correction means has corrected the time count means is made by displaying the notification on a television monitor connected, as the monitor output unit, to the video receiver.

3. The video receiver according to claim 1 or 2, wherein one of an EPG, an EDS, a CCD, and a T'TEXT is received as a broadcast of transmitting the broadcast signal for acquiring the correction time information.

4. The video receiver according to any one of claims 1 to 3, wherein a broadcast of transmitting a voice signal representing a time signal sound at a certain time is received as a broadcast of transmitting the broadcast signal for acquiring the correction time information.
